(19) United States
(12) Patent Application Publication
(10) Pub. No.: US 2023/0003450 A1
(43) Pub. Date: Jan. 5, 2023

(54) INTELLIGENT SYSTEM FOR CONTROLLING OPERATIONAL PARAMETERS OF A SMELTING FURNACE

(71) Applicant: CODELCOTEC SPA, Región Metropolitana, Santiago (CL)

(72) Inventors: Fuentes Weishaupt Claudio, Región Metropolitana, Santiago (CL); Contreras Rojas Leonel, Región Metropolitana, Santiago (CL); Weishaupt Silva Rodolfo, Región Metropolitana, Santiago (CL); Cabello Saez Gustavo, Región Metropolitana, Santiago (CL)

(21) Appl. No.: 17/756,582

(22) PCT Filed: Nov. 27, 2020
(86) PCT No.: PCT/CL2020/050164

§ 371 Date: May 27, 2022

(30) Foreign Application Priority Data
Nov. 29, 2019 (CN) 201911198608.9

(51) Int. Cl. F27B 3/28; F27D 21/00; F27B 3/08; F27D 19/00; G01N 23/20; C22B 15/00

(52) U.S. Cl. CPC F27B 3/28; F27D 21/0028; F27B 3/085; F27D 19/00; F27D 21/0014; F27D 21/0021; G01N 23/20; C22B 15/0095; F27D 2019/0003; F27D 2019/0096; G01N 2223/05; G01N 2223/60; C22B 15/0039

(57) ABSTRACT

This application addresses an integrated smart system to control the variables involved in the process for melting mineral concentrates. Specifically, it addresses an integrated smart system that allows the whole melting process operation to be controlled, measuring the mineralogical quality and quantity of the concentrate that is injected into the melting furnace, as well as variables such as the temperature, the level of the liquid phases and the percentage of copper within the furnace. In this manner, by reading said variables, it acts autonomously on manipulated variables, considering uncertainties, allowing a stable temperature to be maintained in the reactor, allowing products to be obtained at the required quality and controlling the liquid phases therein, among other controlled variables, to achieve efficient melting.

This application addresses an integrated smart system to control the variables involved in the process for melting mineral concentrates. Specifically, it addresses an integrated smart system that allows the whole melting process operation to be controlled, measuring the mineralogical quality and quantity of the concentrate that is injected into the melting furnace, as well as variables such as the temperature, the level of the liquid phases and the percentage of copper within the furnace. In this manner, by reading said variables, it acts autonomously on manipulated variables, considering uncertainties, allowing a stable temperature to be maintained in the reactor, allowing products to be obtained at the required quality and controlling the liquid phases therein, among other controlled variables, to achieve efficient melting.

### BACKGROUND

Due to the ongoing search to improve pyrometallurgical melting processes, it becomes increasingly necessary to have control tools that allow actions to be performed in a timely manner on the variables involved, to achieve optimal results in the overall process itself. In the prior art, it is possible to see solutions intended to control or measure specific variables within the process, such as those that occur within a reactor or furnace. However, these are not autonomous or smart, nor are they integrated into the control or measurement of the other relevant variables involved in order to have overall automated smart control over the melting process.

For example, patent registration CL 49,311 describes methods and systems to determine the height of liquid or molten metals within metal smelting, shaft, matte or slag reactors. This system, via the application of a signal outside of the smelting bath, determines, in line, the height of the phases, enabling the height of the slag-matte interface and total level of the bath to be obtained. However, being a very good tool to observe what is occurring with the phases within the reactor, it is not integrated with the other variables involved in melting, such as temperature and the mineralogical characteristics of the injected concentrate.

The publication of patent WO2017066348 describes systems and methods for developing hierarchical smart asset control applications and optimizing the integrated smart asset control system. The system can develop a hierarchical asset control application and the corresponding control hardware requirements. This may be used to create an Integrated Smart Asset Control System to execute various processes for a set of equipment elements. The smart assets associated with the system may use smart agents to balance operational restrictions and operational objects to determine optimized operational parameters in real time for a process and implement appropriate controls to facilitate the achievement of improved operational objectives. Unlike the invention, this publication generically shows how to control some variables involved in the reactor. However, it does not show how to control variables related to the mineralogical characteristics of the injected concentrate, the height of the liquid phases within the reactor or how said variables may be interconnected in order to autonomously influence the operation of the furnace or reactor.

The publication of patent US2014107810 describes methods and instruments to control the use of field and control devices that provide a virtual machine environment and communicate via an IP network. For example, the field device may be a transmitter or “smart” actuator that includes a low-power processor together with a random-access memory, a read-only memory, a FlashRAM and a sensor interface. The processor can execute an operating system in real time, as well as a Java virtual machine (JVM). The Java bytecode is executed on the JVM to configure the field device to perform typical process control functions, for example, for the proportional-integral-derivative (PID) control and signal conditioning. The control networks may include a plurality of said field and control devices interconnected via an IP network, such as Ethernet. In this publication, a smart system to control a machine can be observed, but it does not mention, in any way, the variables this invention integrates into the system. However, the publication is a good example of the general direction in which the technology is headed with regard to having tools that allow devices to be controlled autonomously.

The publication of patent CN105334736 describes a method for controlling the heating temperature of a furnace based on the fractional order model predictive control for an extended space to maintain the stability of a fractional order system and guarantee good control performance. The method for controlling the heating temperature of the furnace based on the fractional order model predictive control includes the steps by which it is adopted. First, an Oustaloup approximation method [is used] to approximate a fractional order model to an order model above overall order, then an extended state space model is established based on the higher order model approximated. Next, a fractional calculation operator is introduced in an objective function and a functional fractional order prediction controller is designed based on the extended state space model and the selected objective function. The method for controlling the heating temperature of the furnace, based on the fractional order predictive control, can be applied to a practical process object described by the fractional order object. This overcomes the deficiencies of an overall order MPC method in the control aspect of the fractional order control of the system. Meanwhile, this improves the degree of freedom in adjusting controller parameters, obtaining good control performance and satisfying the demands of the actual industrial process.

This publication shows how to have smart control over the temperature of a furnace. However, it does not show how to connect said variables to the others involved in the process, which is something the invention's system does do.

Thus, the need arises to have a system that allows the relevant variables within a melting process to be controlled, such as the mineralogical characteristics of the injected concentrate, the reaction temperature within the furnace, the copper percentage and the height of the liquids that comprise the phases within the furnace, making them interact with each other via an integrated smart system such as that of this invention.

### BRIEF DESCRIPTION OF THE FIGURES

FIG. 1: represents a diagram that illustrates the integrated smart system in consultant mode.

FIG. 2: represents a diagram that illustrates the integrated smart system in automatic mode.

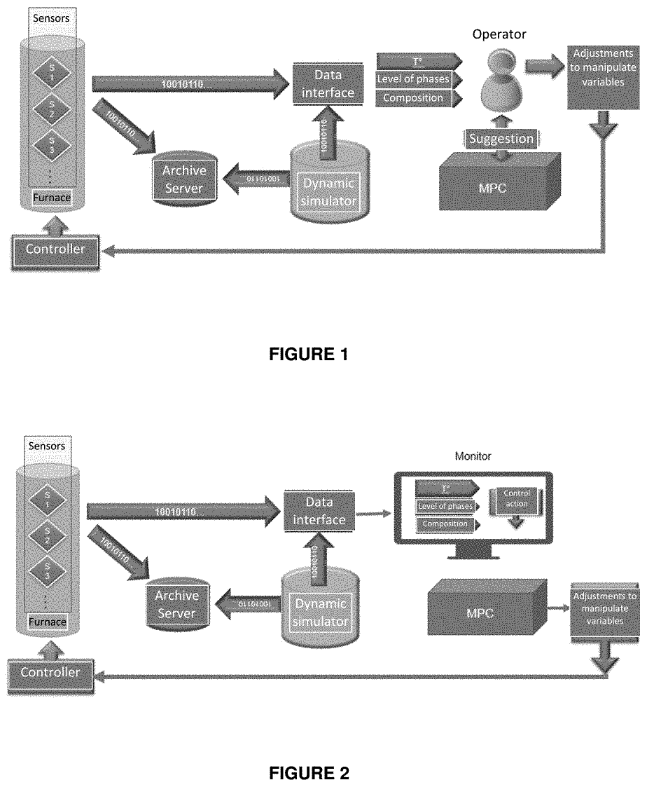

### DETAILED DESCRIPTION OF THE INVENTION

The invention consists of a predictive control system that integrates control sub-systems, pyrometallurgical models, information from sensors (S1, S2, S3, etc.), operation restrictions and process uncertainties, which is oriented towards determining control actions that aim to improve the stability of the critical variables of the process in the melting furnace. Thanks to the control actions being calculated by the invention's system, the productivity, quality and continuity of the process are positively influenced, which translates into an increase in the campaign time of the furnace. As a positive consequence, damage to the furnace caused by overheating or leaks in the nozzles or passages is avoided.

This system is composed of four specific sub-systems: a sub-system for the detection and quantification of mineralogical species via x-ray diffraction (XRD) of the concentrate of dry copper before being injected into a converter or melting furnace; a sub-system to determine the height of phases or levels of liquid or molten metals within a melting furnace; a sub-system to measure temperature and the thickness of refractory materials for melting furnaces and a sub-system to measure, in line and in real time, the percentage of copper in the main product of a melting furnace. These four sub-systems are interlinked to increase the reliability of the melting process by measuring critical variables so as to maintain the stability of the process, optimizing the consumption of circulants, increasing the duration of refractory materials, reducing costs and increasing melting capacities by measuring variables such as the mineralogy and chemical composition of concentrates, which are fed into a simulator of the process that indicates the optimal operation [conditions], and by controlling and measuring the height of the phases within the melting furnace.

The four sub-systems that comprise the invention's system are integrated into a processor that incorporates advanced control software for the four sub-systems. Said processor is connected to an interface that transmits data from the melting furnace. Said transmission can be performed via a wired or wireless connection from the sensors for each of the four aforementioned sub-systems.

In a preferred embodiment of the invention, the data interface where the measurements of the critical variables are obtained is connected to a dynamic process simulator that allows, based on a reading of the temperature variables, the mineralogical characteristics of the concentrate, the height of phases and the percentage of copper within the furnace, what is occurring within the reactor to be observed when these variables are changed or influenced by the integrated smart system. If the result observed in the dynamic simulator is favorable to the melting process, only then will data be transmitted to vary or influence the parameters within the furnace. Additionally, the dynamic simulator will be used as a virtual sensor that will provide a measurement of the level of the phases inside the furnace, the percentage of copper in the white metal, a mineralogical analysis of the concentrate and the temperature inside the furnace, in line, in the event that one of the sensors of any of the sub-systems fails. Strictly speaking, the mineralogical analysis of the concentrate is an input for the simulator and based on these characteristics, the other three missing variables can be determined (copper percentage, temperature, level of phases), due to the fact that the basis thereof incorporates phenomenological equations (balance of mass and heat).

In this regard, the dynamic process simulator allows optimizations to be performed on the operation in real time, based on pyrometallurgical models, measurements from the temperature sensors, mineralogical characteristics, a chemical analysis of the concentrate and the height of the phases, for each respective sub-system.

The invention's system allows, as a control objective, temperature stabilization inside the melting furnace (bath smelting) and obtaining products, white metal and slag at the required quality, integrating critical variables from field instruments.

The sub-system for the detection and quantification of mineralogical species via x-ray diffraction (XRD) of the concentrate of dry copper before being injected into a converter or melting furnace is composed of a device that performs a mineralogical analysis, in line and in real time, of the concentrate of copper in the bath smelting furnace via x-ray diffraction (XRD), which allows for control over the ideal mixture for the optimal process for copper sulfide (Cu₂S)-white metal, iron sulfide (FeS)-Slag and pyritic sulfur (S₂)-temperature.

The sub-system to determine the height of phases or the level of liquid or molten metals within a melting furnace is comprised of a programmable logic controller (PLC) equipped with a wireless transmitter-receiver device that has analog inputs and discrete outputs connected to a circuit of solid-state relays and electromechanical relays. The circuit is connected to electrodes (that ultimately are the sensors for this sub-system) arranged within the melting furnace. The electrodes are submerged in a specific phase of the metallurgical bath within the furnace and the programmable logic controller is connected via the transmitter-receiver device to a control interface. The system allows the level of the molten phases to be determined, in line and in real time, via an algorithm that includes variables relevant to the resistance in the bath produced by voltage injection and current circulation.

The sub-system to measure the temperature and the thickness of refractory materials for melting furnaces is comprised of a bar of refractory steel with holes to house an array of sensors, which serves as a thermal conductor and support or chassis for the array. The steel bar is placed in the mantle and/or head of the melting furnace. The system allows the temperature inside the furnace to be determined, in line and in real time, via an algorithm that includes relevant variables from the information provided by the sensor array.

The sub-system to measure, in line and in real time, the percentage of the content of copper in the main product of the melting furnace is comprised of at least four aligned electrodes inserted through the refractory wall of the melting furnace, so that one end of each electrode is outside the furnace and the other end is inside where the smelting reaction is occurring, that is to say, it is inserted in the smelting bath. The electrodes are connected to a signal amplifier, which in turn is connected to a signal generator. A power generator sends a replicated signal from the signal generator, sending the current-boosted signal for loads with a resistance of less than 0.1 ohm and a bandwidth of 3 MHz. The power amplifier sends the power signal to the electrodes placed at the ends of the line, so that the electrodes in the center receive the resistivity reading once the signal has been sent.

The invention's system, in turn, can operate in consultant mode or in automatic mode. Consultant mode acts in support of the operation, obtaining the control actions to be applied to the system, which are observed visually as recommendations via the operation interface. Strictly speaking, in consultant mode, it does not perform control actions with the system's actuators, but provides suggestions to adjust the variables manipulated by the operator. Conversely, the automatic mode performs control actions and the operator can monitor performance via the operation interface. The dynamic simulator functions as a backup for the sensors of each sub-system. In the event any failure whatsoever occurs, it switches into automatic mode, in which it is possible for the dynamic process simulator to act, providing data to replace the flawed or missing data. The dynamic process simulator can operate in either mode of operation.

1. An integrated smart system to control the variables involved in the process for melting mineral concentrates, which allows operation optimizations to be performed in real time, based on predictive models, in order to control and subsequently stabilize the temperature of the melting furnace (bath smelting) revolving around a [certain] point of operation and to obtain products of the required quality, integrating critical variables from field instruments, CHARACTERIZED in that it is composed of four specific sub-systems: one sub-system for the detection and quantification of mineralogical species via x-ray diffraction (XRD) of the concentrate of dry copper before being injected into a converter or melting furnace; one sub-system to determine the height of phases or levels of liquid or molten metals within a melting furnace; one sub-system to measure the temperature and thickness of refractory materials for melting furnaces and one sub-system to measure, in line and in real time, the percentage of copper in the main product of a melting furnace. Each sub-system has measurement sensors specifically for their respective functions and said sub-systems are integrated into a processor that incorporates advanced control software to control the four sub-systems. Said processor is connected to an interface for the data transmitted from the melting furnace.

2. Integrated smart system to control the variables involved in the process for melting mineral concentrates in accordance with claim 1, CHARACTERIZED in that said transmission is performed via a wired connection to the sensors for each of said four sub-systems.

3. Integrated smart system to control the variables involved in the process for melting mineral concentrates in accordance with claim 1, CHARACTERIZED in that said transmission is performed via a wireless connection to the sensors for each of said four sub-systems.

4. Integrated smart system to control the variables involved in the process for melting mineral concentrates in accordance with claim 1, CHARACTERIZED in that said data interface is connected to a dynamic process simulator.

5. Integrated smart system to control the variables involved in the process for melting mineral concentrates in accordance with claim 1, CHARACTERIZED in that said sub-system for the detection and quantification of mineralogical species via x-ray diffraction (XRD) of the concentrate of dry copper before being injected into the converter or melting furnace is comprised of a device that performs a mineralogical analysis, in line and in real time, of the concentrate of copper in the bath smelting furnace via x-ray diffraction (XRD), which allows for control over the ideal mixture for the optimal process for copper sulfide (Cu₂S)-white metal, iron sulfide (FeS)-Slag and pyritic sulfur (S₂)-temperature, given the availability of material and given that the sub-system provides, as a measurement, the mineralogy of the copper concentrate, in line.

6. Integrated smart system to control the variables involved in the process for melting mineral concentrates in accordance with claim 1, CHARACTERIZED in that said sub-system to determine the height of phases or levels of liquid or molten metals within a melting furnace is comprised of a programmable logic controller (PLC) equipped with a wireless transmitter-receiver device that has analog inputs and discrete outputs connected to a circuit of solid-state relays and electromechanical relays. The circuit is connected to electrodes (that ultimately are the sensors for this sub-system) arranged within the melting furnace. The electrodes are submerged in a specific phase of the metallurgical bath within the furnace and the programmable logic controller is connected via a transmitter-receiver device to a control interface. The system allows the level of the molten phases to be determined, in line and in real time, via an algorithm that includes variables relevant to the resistance in the bath produced by voltage injection and current circulation.

7. Integrated smart system to control the variables involved in the process for melting mineral concentrates in accordance with claim 1, CHARACTERIZED in that said sub-system to measure the temperature and the thickness of refractory materials for melting furnaces is comprised of a bar of refractory steel with holes to house an array of sensors, which serves as a thermal conductor and support or chassis for the array. The steel bar is placed in the mantle and/or head of the melting furnace. The system allows the temperature inside the furnace to be determined, in line and in real time, via an algorithm that includes relevant variables from the information provided by the sensor array.

8. Integrated smart system to control the variables involved in the process for melting mineral concentrates in accordance with claim 1, CHARACTERIZED in that said sub-system to measure, in line and in real time, the percentage of copper in the main product of a melting furnace is comprised of at least four aligned electrodes inserted through the refractory wall of the melting furnace, so that one end of each electrode is outside the furnace and the other end is inside where the melting reaction is occurring, that is to say, it is inserted in the smelting bath. Said electrodes are connected to a signal amplifier, which in turn is connected to a signal generator. A power generator sends a replicated signal from the signal generator, sending the current-boosted signal for loads with a resistance of less than 0.1 ohm and a bandwidth of 3 MHz. The power amplifier sends the power signal to the electrodes placed at the ends of the line, so that the electrodes in the center receive the resistivity reading once the signal has been sent.

9. Integrated smart system to control the variables involved in the process of melting mineral concentrates in accordance with claim 1, CHARACTERIZED in that it can operate in consultant mode or in automatic mode.
